(19) United States
(12) Patent Application Publication
(10) Pub. No.: US 2020/0307150 A1
(43) Pub. Date: Oct. 1, 2020

(54) STICKY FABRICS AND GARMENT MADE OF THE SAME

(71) Applicant: Mackent Fabrics Co., Ltd., Taoyuan City (TW)

(72) Inventor: Chang-Chi Wang, Taoyuan City (TW)

(21) Appl. No.: 16/832,651

(22) Filed: Mar. 27, 2020

Related U.S. Application Data
(60) Provisional application No. 62/824,586, filed on Mar. 27, 2019.

(51) Int. Cl. B32B 5/26; A41C 3/00; A41C 3/06; D01F 6/62

(52) U.S. Cl. CPC B32B 5/26; A41C 3/0014; A41C 3/065; B32B 2262/0284; B32B 2405/00; D10B 2331/04; B32B 2262/0292; D01F 6/62

(57) ABSTRACT

A garment is provided with at least a portion of cloth being made of a fabric structure. According to the present invention, the fabric structure comprises an outer fabric layer, an inner fabric layer and a central fabric layer. The outer fabric layer is knitted with nylon-contained fibers, and the inner fabric layer is knitted with PU-dominated sticky fibers. The central fabric layer is interposed between the outer fabric layer and the inner fabric layer and knitted with wave-like fibers. The wave-like fibers are intertwined with the nylon-contained fibers and the PU-dominated sticky fibers respectively. Therefore, the inner fabric layer is in close contact with the skin of the user to provide mild stickiness.

The present application claims the priority of Provisional Application No. 62/824,586, entitled “STICKY FABRICS IMPLEMENTED WITH NYLON,” filed on Mar. 27, 2019 under 35 U.S.C. 119.

### BACKGROUND OF THE INVENTION

### 1. Technical Field

The present invention relates to an improved fabric structure and, more particularly, to a novel fabric structure which enables a garment made thereof to be somewhat sticky to the skin of a wearer while being in close contact with the wearer's skin.

### 2. Description of Related Art

People's requirements for the fabric structure of clothes are increasing. It is desirable that the fabric structure is breathable, effective in heat dissipation, sweat absorbent, comfortable, and lightweight. Consequently, a variety of weaving methods, fiber materials, and fiber arrangements for the fabric structure of garments were developed.

Take brassieres for example. It is generally required that a bra provides sufficient support for the breasts and will not slip easily. When it comes to bras without shoulder straps, it is further required that such a bra is in close contact with the wearer's skin and will stay where it is supposed to be without slipping; otherwise, the wearer is subject to the embarrassment of having the bra shifted in position.

### BRIEF SUMMARY OF THE INVENTION

In order to solve the forgoing problems, one object of this invention is to provide a fabric structure, wherein the inner fabric layer is substantially knitted with the sticky fibers and thus features superior stretchability, superior resilience, mild stickiness and slip-proofness.

Accordingly, the present invention provides a fabric structure comprises an outer fabric layer, an inner fabric layer and a central fabric layer. The outer fabric layer is knitted with nylon-contained fibers, and the inner fabric layer is knitted with PU-dominated sticky fibers. The central fabric layer is interposed between the outer fabric layer and the inner fabric layer and knitted with wave-like fibers. The wave-like fibers are intertwined with the nylon-contained fibers and the PU-dominated sticky fibers respectively.

Moreover, the present further provides a garment provided with at least a portion of cloth being made of a fabric structure. The fabric structure comprises an outer fabric layer, an inner fabric layer and a central fabric layer. The outer fabric layer is knitted with nylon-contained fibers, and the inner fabric layer is knitted with PU-dominated sticky fibers. The central fabric layer is interposed between the outer fabric layer and the inner fabric layer and knitted with wave-like fibers. The wave-like fibers are intertwined with the nylon-contained fibers and the PU-dominated sticky fibers respectively. Therefore, the inner fabric layer is in close contact with the skin of the user to provide mild stickiness.

### BRIEF DESCRIPTION OF THE DRAWINGS

The structure and advantages of the present invention will be best understood by referring to the following detailed description of an illustrative embodiment in conjunction with the accompanying drawings, in which:

FIG. 1 is an exploded view schematically showing a fabric structure according to one embodiment of the present invention;

FIG. 2 is an integral view schematically showing the fabric structure according to one embodiment of the present invention;

FIG. 3 is a diagram schematically showing an outer fabric layer of a fabric structure according to another embodiment of the present invention; and

FIG. 4 is a diagram schematically showing an application of the fabric structure according to one embodiment of the present invention.

### DETAILED DESCRIPTION OF THE INVENTION

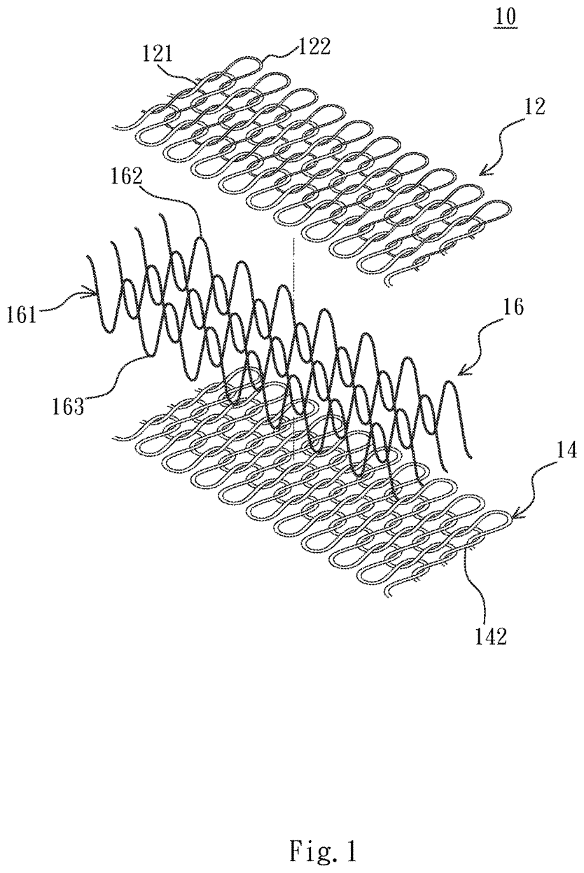

Refer to FIG. 1 an exploded view schematically showing a fabric structure according to one embodiment of the present invention. The fabric structure 10 of the present invention includes an outer fabric layer 12, an inner fabric layer 14 and a central fabric layer 16. The outer fabric layer 12 is knitted with nylon-contained fibers. As shown in FIG. 1, the nylon-contained fibers include a plurality of nylon fibers 121 and a plurality of non-nylon fibers 122 both knitted into the outer fabric layer 12 together. The inner fabric layer 14 is a PU (polyurethane)-dominated layer which includes a plurality of PU (polyurethane) fibers 142 as an example. In other words, the plurality of PU fibers are knitted into the inner fabric layer 14. The central fabric layer 16 is interposed between the outer fabric layer 12 and the inner fabric layer 14. The central fabric layer 16 consists of a plurality of wave-like fibers 161. As shown in FIG. 1, the crests 162 of the wave-like fibers 161 are intertwined with the nylon fibers 121 and the non-nylon 122 of the outer fabric layer 12. The troughs 163 of the wave-like fibers 161 are intertwined with the nylon fibers 142 of the inner fabric layer 14. In other words, the wave-like fibers 161 are intertwined between the outer fabric layer 12 and the inner fabric layer 14.

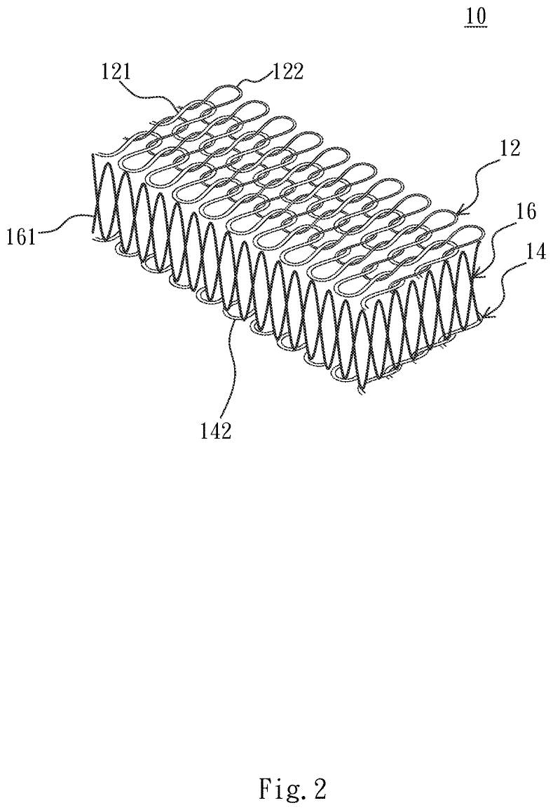

In one embodiment, the outer fabric layer 12 and the inner fabric layer 14 are knitted in a weft or a warp knitting method. Preferably, a circular knitting method can be employed to knit the inner fabric layer 14 and the outer fabric layer 12. Because of the characteristics of PU material, the inner fabric layer 14, which is primarily knitted with the PU fibers 142, is intrinsically provided with stretchability and mild stickiness. Referring to FIG. 2 an integral view schematically showing a fabric structure according to one embodiment of the present invention, the fabric structure 10 includes three fabric layers: the outer fabric layer 12, the inner fabric layer 14 and the central fabric layer 16. In the embodiment, the central fabric layer 16 is knitted with the wave-like fibers 161 in a 3D knitting method and thus has a ripple-like appearance. The wave-like fibers 161, which are used to knit the central fabric layer 16, is made of monofilament fibers or multifilament fibers.

In the foregoing embodiment, the outer fabric layer 12 is knitted with the plurality of nylon fibers 121 and the plurality of non-nylon fibers 122. Preferably, the non-nylon fibers 122 can be made of a material selected from a group consisting of PET (polyethylene terephthalate), polyester, PU (polyurethane), CD (cationic dyeable) yarn, decomposable material (such as cellulosic yarn), recyclable material (such as PET bottle or fish net) or the like, and any combination thereof. Furthermore, the central fabric layer 16 is knitted in a 3D knitting method and has a ripple-like appearance. The central fabric layer 16 can be knitted with monofilament fibers or multifilament fibers made of a material selected from a group consisting of PET (polyethylene terephthalate), polyester, nylon, PU (polyurethane), CD (cationic dyeable) yarn, decomposable material (such as cellulosic yarn), recyclable material (such as PET bottle or fish net) or the like, and any combination thereof. The inner fabric layer 14 can be dominantly knitted with the PU fibers 142; that is, primarily knitted with the PU fiber 142 plus, minorly, a plurality of other fibers made of a material selected from a group consisting of PET (polyethylene terephthalate), polyester, nylon, CD (cationic dyeable) yarn, decomposable material (such as cellulosic yarn), recyclable material (such as PET bottle or fish net) or the like, and any combination thereof.

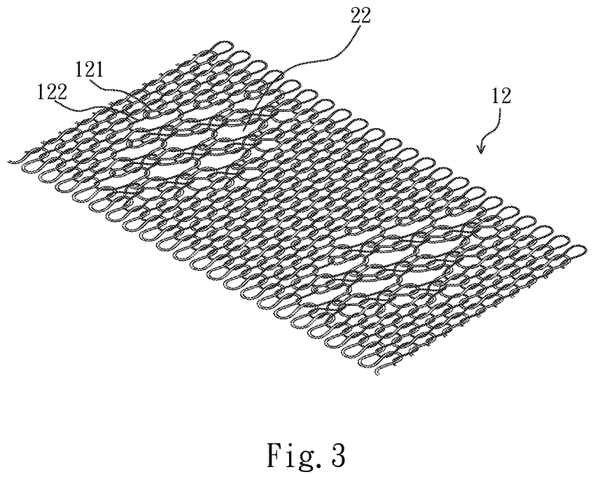

Refer to FIG. 3 a diagram schematically showing an outer fabric layer of a fabric structure according to another embodiment of the present invention. In this embodiment, the outer fabric layer 12 is knitted to have Jacquard patterns 22 to promote the esthetic effect.

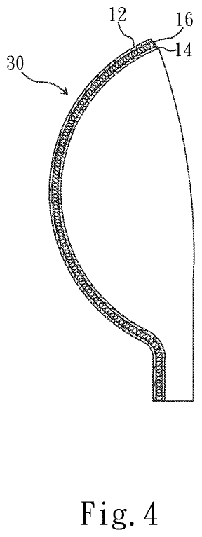

The fabric structure of the present invention may be used as the cloth for female bra. As exemplified in FIG. 4, while a woman wears the bra 30 made of the fabric structure 10 of the present invention, the wave-like central fabric layer 16 has a superior moisture permeation effect and a superior air permeation (heat dissipation) effect. The inner fabric layer 14, which is dominantly knitted with the PU fibers 142 and features stretchability and mild stickiness, can support the breast very well. Further, the mild stickiness makes the bra contacts the skin intimately and resistively to slip. Therefore, the fabric structure 10 of the present invention can enhance the supportability of the bra and make the bra contact the skin intimately.

In present invention, the outer fabric layer 12, the central fabric layer 16 and the inner fabric layer 14 of the fabric structure 10 are all fabricated in knitting methods. The inner fabric layer 12 is dominantly knitted with the stretchable and sticky PU fibers 142 and thus features superior stretchability, superior resilience, mild stickiness and slip-proofness.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A fabric structure comprising:
an outer fabric layer knitted with nylon-contained fibers;
an inner fabric layer knitted with PU-dominated sticky fibers; and
a central fabric layer interposed between the outer fabric layer and the inner fabric layer and knitted with wave-like fibers, wherein the wave-like fibers intertwined with the nylon-contained fibers and the PU-dominated sticky fibers respectively.

2. The fabric structure as claimed in claim 1, wherein the nylon-contained fibers comprise nylon yarns.

3. The fabric structure as claimed in claim 2, wherein the nylon-contained fibers further comprise a material selected from a group consisting of PET, polyester, PU, CD yarn, decomposable material, and recyclable material.

4. The fabric structure as claimed in claim 1, wherein the PU-dominated sticky fibers comprise PU yarns.

5. The fabric structure as claimed in claim 4, wherein the plurality of PU-dominated sticky fibers further comprise a material selected from a group consisting of PET, polyester, nylon, CD yarn, decomposable material and recyclable material.

6. The fabric structure as claimed in claim 1, wherein the wave-like fibers are monofilament or multifilament fibers.

7. The fabric structure as claimed in claim 6, wherein the wave-like fibers are made of a material selected from a group consisting of PET, polyester, nylon, PU, CD yarn, decomposable material and recyclable material.

8. The fabric structure as claimed in claim 1, wherein a portion of the nylon-contained fibers are knitted into at least one Jacquard pattern on the upper fabric layer.

9. A garment provided with at least a portion of cloth being made of a fabric structure comprising:
an outer fabric layer knitted with nylon-contained fibers;
an inner fabric layer knitted with PU-dominated sticky fibers; and
a central fabric layer interposed between the outer fabric layer and the inner fabric layer and knitted with wave-like fibers, wherein the wave-like fibers are intertwined with the nylon-contained fibers and the PU-dominated sticky fibers respectively;
wherein the inner fabric layer is in close contact with the skin of the user to provide mild stickiness.

10. The garment as claimed in claim 9, wherein the nylon-contained fibers comprise nylon yarns.

11. The garment as claimed in claim 10, wherein the nylon-contained fibers further comprise a material selected from a group consisting of PET, polyester, PU, CD yarn, decomposable material, and recyclable material.

12. The garment as claimed in claim 9, wherein the PU-dominated sticky fibers comprise PU yarns.

13. The garment as claimed in claim 12, wherein the plurality of PU-dominated sticky fibers further comprise a material selected from a group consisting of PET, polyester, nylon, CD yarn, decomposable material and recyclable material.

14. The garment as claimed in claim 9, wherein the wave-like fibers are monofilament or multifilament fibers.

15. The garment as claimed in claim 14, wherein the wave-like fibers are made of a material selected from a group consisting of PET, polyester, nylon, PU, CD yarn, decomposable material and recyclable material.

16. The garment as claimed in claim 9, wherein a portion of the nylon-contained fibers are knitted into at least one Jacquard pattern on the upper fabric layer.
